(19) United States
(12) Patent Application Publication
(10) Pub. No.: US 2012/0215530 A1
(43) Pub. Date: Aug. 23, 2012

(54) METHOD AND SYSTEM FOR SPEECH ENHANCEMENT IN A ROOM

(75) Inventor: Samuel Harsch, Ballaigues (CH)

(73) Assignee: PHONAK AG, Staefa (CH)

(21) Appl. No.: 13/504,652

(22) PCT Filed: Oct. 27, 2009
(86) PCT No.: PCT/EP09/64145

§ 371 Date: Apr. 30, 2012

(51) Int. Cl. G10L 21/02; G10L 21/00

(52) U.S. Cl. 704/225; 704/E21.001; 704/E21.002

(57) ABSTRACT

A method of speech enhancement in a room (10), having the steps of: determining acoustic parameters of the room and a loudspeaker arrangement (24) located in the room, capturing audio signals from a speaker's voice with a microphone (12), and processing the captured audio signals with an audio signal processing unit (20). The audio signals are filtered by applying a selected frequency response curve to the audio signals, generating sound according to the processed audio signals by the loudspeaker arrangement, determining a value indicative of the overall gain applied to the captured audio signals, and selecting a frequency response curve to be applied to the captured audio signals according to the overall gain value and the acoustic parameters.

### BACKGROUND OF THE INVENTION

1. Field of the Invention

The present invention relates to a system for speech enhancement in a room, comprising a microphone for capturing audio signals from a speaker's voice, an audio signal processing unit for processing the captured audio signals and a loudspeaker arrangement located in the room for generating sound according to the processed audio signal.

2. Description of Related Art

Speech enhancement systems of the initially mentioned type are used for amplifying the speaker's voice in order to enhance intelligibility of the speech by the listeners. U.S. Pat. No. 7,822,212 relates to such a speech enhancement system, wherein the shape of the frequency response curve applied to the audio signals in the audio signal processing unit is selected as a function of the ambient noise level in the room as estimated by the system. At higher ambient noise level frequency response curves, the lower frequency cutoff level is increased.

Often HiFi systems include a function labeled “loudness” or “contour”, which changes the frequency response as a function of the sound level in order to take into account that the frequency response of the hearing depends on the loudness level. In the case of U.S. Pat. No. 7,822,212, the frequency response of the gain function is determined so as to compensate for the removal of the lower frequency ranges by increasing the gain in the remaining frequency gain bandwidth and can be compensated according to human hearing perception.

### SUMMARY OF THE INVENTION

It is an object of the invention to provide a speech enhancement system which allows speech intelligibility to be optimized. It is a further object to provide for a corresponding speech enhancement method.

According to the invention, these objects are achieved by a speech enhancement method and a speech enhancement system as described below.

The invention is beneficial in that, by selecting the frequency response curve applied by the audio signal processing unit according to the estimated overall gain and the acoustic parameters of the room and the loudspeaker arrangement located in the room, speech intelligibility can be increased; in particular, the frequency response curve may be selected in such a manner that the free field frequency response of the speaker's voice is approximated as close as possible at a listener's position in the room.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 is a schematic block diagram of a speech enhancement system according to the invention;

FIG. 2 is a plot of a normalized frequency response of a sound source in free field, the respective power response of the source and the respective frequency response of the reverberant field, respectively;

FIG. 3 is bar graph depicting an example of the RT60 of a room at different frequencies;

FIG. 4 is a plot of the frequency response of the reverberant field in a classroom, the frequency response of the direct field of the sound source in a classroom out of axis, and the normalized reference frequency response of the source in free field, respectively;

FIG. 5 is a plot showing an example of the frequency response of a voice source (speaker) without amplification at a typical listening point in a classroom and of a typical frequency response, at the same listening position, of the sound as amplified by a speech enhancement system according to the prior art;

FIG. 6 is a plot of the frequency response of a speaker at a typical listening position in a classroom and of an example of a frequency response curve applied in a speech enhancement system according to the invention, when the system gain is about 1;

FIG. 7 is a graph like that of FIG. 6, wherein the system gain is above 1, with the same frequency response curve as in FIG. 6 having been selected;

FIG. 8 is a graph like that of FIG. 7, however, with a modified frequency response curve according to the invention having being selected;

FIG. 9 is a graph comparing the frequency response curve selected at a gain of about 1 and the frequency response curve selected at a gain of more than 1;

FIG. 10 is a graph like that of FIG. 9, with some intermediate frequency response curves being shown in addition;

FIG. 11 is a graph that shows a typical gain curve applied on the dynamic equalizer at low frequencies by a system according to the invention;

FIG. 12 is a graph like that of FIG. 11 for a modified system according to the invention including Fletcher-Munson-curve compensation;

FIG. 13 is a graph like that of FIG. 10 showing frequency response curves used by a system having a gain curve like that shown in FIG. 12;

FIG. 14 is a block diagram of an example of a speech enhancement system according to the invention; and

FIGS. 15 to 17 are block diagrams of modified examples of a speech enhancement system according to the invention.

### DETAILED DESCRIPTION OF THE INVENTION

FIG. 1 is a schematic representation of a speech enhancement system located in a room 10 and comprising a microphone 12 (which in practice may be a directional microphone comprising at least two spaced apart acoustic sensors) for capturing audio signals from the voice of a speaker 14, an audio signal processing unit 20 for processing the audio signals captured by the microphone 12, a power amplifier 22 for amplifying, at constant gain, the processed audio signals and a loudspeaker arrangement 24 for generating amplified sound according to the processed audio signals for listeners 26.

In the audio signal processing unit 20, the audio signals captured by the microphone 12 undergo pre-amplification and frequency filtering prior to being amplified by the power amplifier 22. The system acts to increase the level of the voice of the speaker 14 at the position of the listeners 26 by amplifying the voice captured by the microphone 12. The goal of such a system is to enhance speech intelligibility at the position of the listeners 26. Typical speech enhancement systems of the prior art are designed to linearly amplify the voice of the speaker 14. Such an approach does not take into account that (1) the frequency response of an acoustic source in a room is modified by its power response and by the acoustic adsorption of the room; and that (2), depending on the gain of the system, the mixing ratio of the direct voice and the voice as amplified by the system is different. These two phenomena have a negative impact on the speech intelligibility.

When a person (speaker) is speaking in the direction of another person (listener) in free field, the sound travels directly from the mouth of the speaker (source) to the listener's ear (listening point) without any modification. In the absence of noise, the speech transmission index (STI) is maximal under such conditions which are characterized by the absence of reverberation and by a frequency response which is not affected by the directivity of the source.

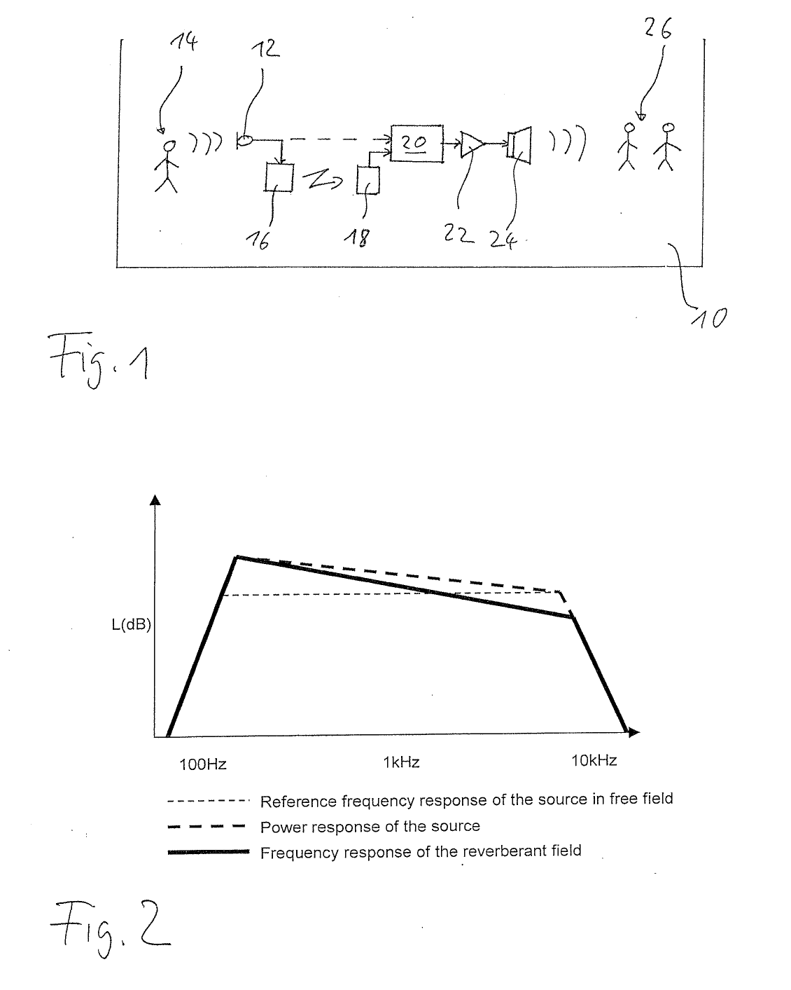

For the following discussion, the free field frequency response is considered to be flat from 100 Hz to 10 kHz and is considered as a normalized reference, see FIG. 2. The normalized reference curve corresponds to the level at an angle of 0°. When the sound source is a human mouth, the directivity of the source increases with frequency: low frequencies are distributed quite omni-directional, whereas higher frequencies are mainly focused in front of the source, i.e., in the 0° direction. The power response of a source is the total acoustic energy radiated in all directions. Hence, when considering the power response of a human mouth having the normalized flat frequency response in the 0°-direction shown in FIG. 1, the lower frequencies have a higher level than the higher frequencies, see FIG. 2. The reason is that the directions other than 0° also provide for significant contributions to the power response of the low frequencies, whereas the power of the higher frequencies is radiated primarily into the 0° direction.

When such a source is placed into a reverberant room, the frequency response of the total reverberant field looks like the power response of the source, because the energy radiated in all directions is acoustically summed due to the reflections at the walls.

In addition, the adsorption coefficient in a typical room depends on frequency and usually is higher at high frequencies than at low frequencies. A typical measure for the adsorption coefficient of a room is the RT60, which is the time needed for the reverberant field to decrease by 60 dB after excitation by an impulse noise. In FIG. 3, an example of the RT60 of a room is shown as a function of frequency, i.e., it is shown for a plurality of frequency bands. Due to the higher absorption at higher frequencies, the RT60 decreases with increasing frequencies. Hence, compared to the power response of the source, the actual frequency response of the reverberant field in a room has an even more pronounced roll-off effect at higher frequencies, see FIG. 2.

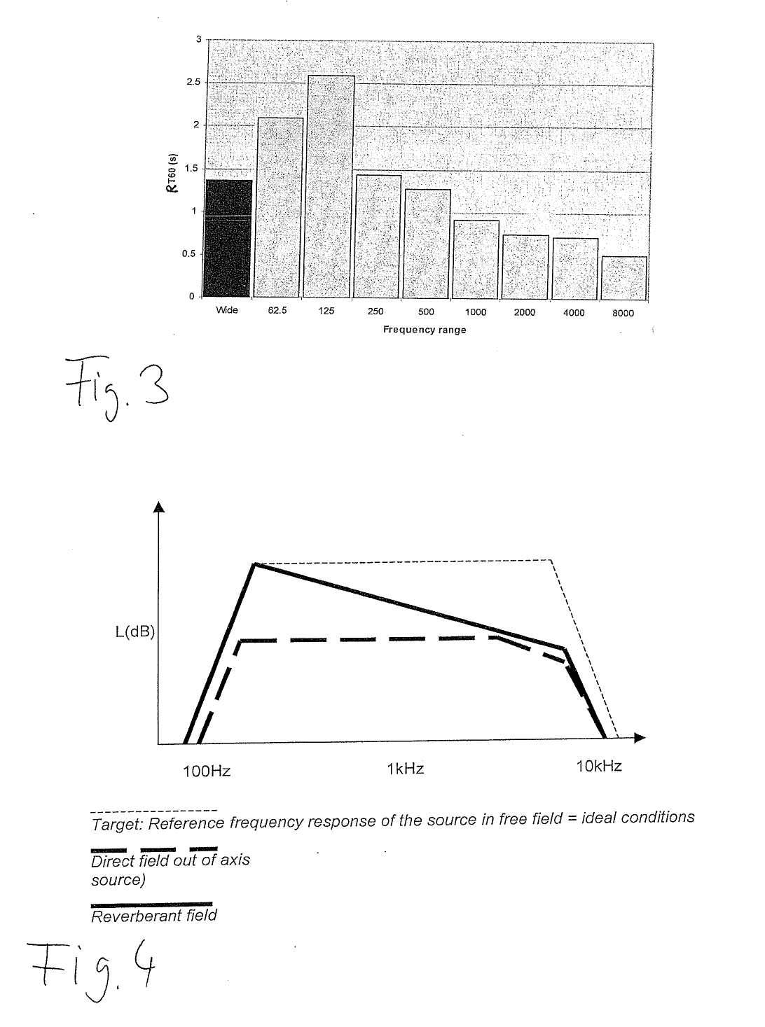

In a standard classroom, most of the students are placed at a position in the reverberant field, where the level of the sum of the reverberation signals is higher than the level of the direct voice of the teacher (i.e., the critical distance is shorter than the distance from the source to the listening point). Due to the directivity of the human mouth, this phenomenon is accentuated when the teacher is not speaking into the direction of the students. As can be seen in FIG. 4, the direct field out of axis has a small decrease at high frequencies compared to the frequency response in the 0° direction. The reverberant field has the same level everywhere in the room; due to the directivity of the source and the frequency dependency of the adsorption coefficient the level is lower at higher frequencies. It can be seen from FIG. 4 that at a typical listener position the perceived sound is dominated by the reverberant field, in which the lower frequencies have a higher level (compared to the free field frequency response) due to the lower directivity and the lower absorption at lower frequencies. However, this effect is detrimental to the speech intelligibility, since higher frequencies, i.e., frequencies above 1 kHz, are most important for good speech intelligibility, whereas the lower frequencies—due to the longer RT60—contribute much less to speech intelligibility and may be even disturbing.

When the speech enhancement system uses standard loudspeakers having a flat frequency response at 0° and having a directivity coefficient which increases with increasing frequency exactly like a human mouth, the result of the speech amplification provided by the system would be only a level shift of almost the same curve, which often would not result in an actual increase in speech intelligibility, since the level of the disturbing late reflections at low frequencies also would increase, see FIG. 5.

However, speech intelligibility could be significantly enhanced by amplifying only that part of the signal, which is missing or weak in the reverberant field at the listening point. Hence, by selecting the appropriate frequency response curve applied to the audio signals in the audio signal processing unit 20 as a function of the total gain provided by the speech enhancement system, the free field frequency response (i.e. a flat curve in the normalized representation) may be approximated. This goal can be achieved by selecting the frequency response curve in such a manner that the amplified sound mixes with the direct sound in such a manner that the total level approaches the flat reference curve of the free field frequency response.

In FIG. 6, an example is shown schematically for a total gain of 1 (at a total gain of 1, the loudspeaker arrangement 24 radiates about the same acoustic power as the speaker 14). As can be seen in FIG. 6, the frequency response curve selected for a gain of about 1 serves to selectively amplify the higher frequencies above about 1 kHz relative to the lower frequencies in order to compensate for the roll-off at higher frequencies in the reverberant field of the sound from the speaker's mouth. In the example of FIG. 6, the sound perceived at the listening point has a frequency distribution which approximates the free field frequency response of the sound from the speaker's mouth.

If the total gain of the system is less than 1, it is not possible to approximate the free field frequency response, since, then, the “loss” at higher frequencies in the reverberant field cannot be fully compensated.

If the gain of the system is increased beyond 1, the loudspeaker arrangement 24 radiates more acoustic power than the speaker's mouth, so that, if the frequency response curve of FIG. 6 is used, the resulting total sound contains too much high-frequency components, so that the perceived sound would no longer be natural, see FIG. 7.

In order to achieve the desired approximation of the free field frequency response, it is necessary to select the shape of the frequency response curve applied in the audio signal processing unit 20 as a function of the total gain of the system. With increasing total gain, the level of the low frequencies relative to the level of the higher frequencies has to be progressively increased in order to compensate for the relative lack in low frequency level in the sound radiated by the speaker's mouth compared to the amplified sound, see FIG. 8. This regime is applied as long as the reverberant field of the loudspeaker arrangement 24 does not completely mask the reverberant field of the sound radiated by the speaker's mouth.

In FIGS. 9 & 10, the change in shape of the selected frequency response curve is illustrated. In particular, at higher gains the level in the low-frequency range below 1 kHz is progressively increased.

In FIG. 11, the resulting low frequency gain curve (i.e., the output at lower frequencies, such as below 1 kHz, as a function of the input) is shown (solid line) and compared with the overall gain of the system (dotted line, according to which at low gain values below a first threshold value T1 (which corresponds to a total gain of 1) the gain curve of the lower frequencies has a constant first slope. When the gain is between the first threshold point and a second threshold point T2 (corresponding to the point where the gain is so high that the direct sound is completely masked by the amplified sound), the gain curve of the lower frequencies has a slope which is steeper than the curve of the overall gain of the system (dotted line). Above the second threshold point, the slope again corresponds to overall gain of the system; in this gain regime, the shape of the selected frequency response curve is kept constant irrespective of the gain.

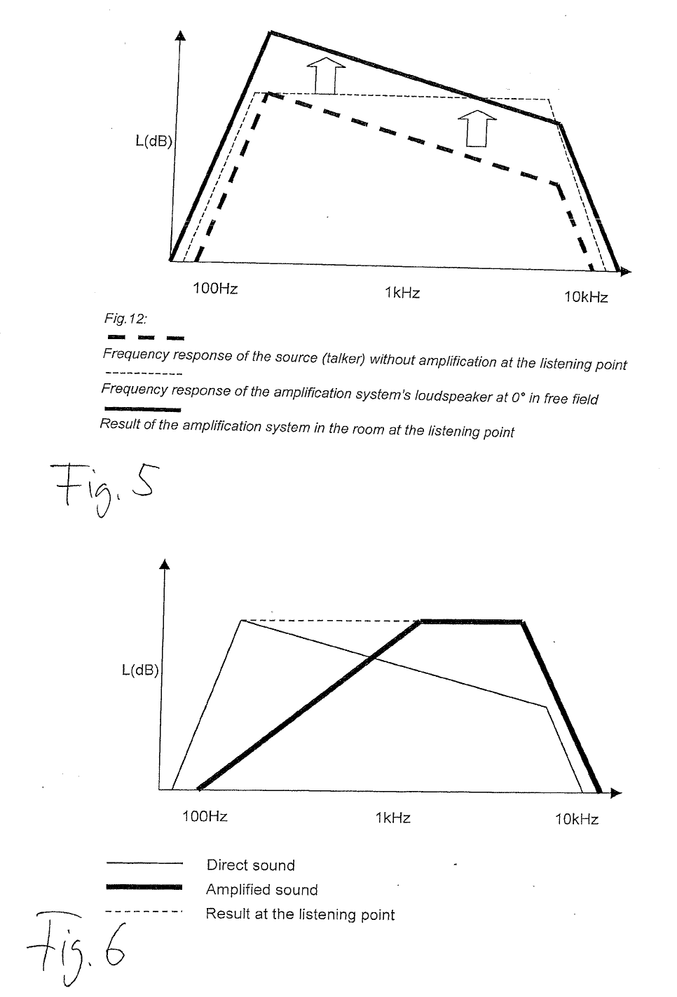

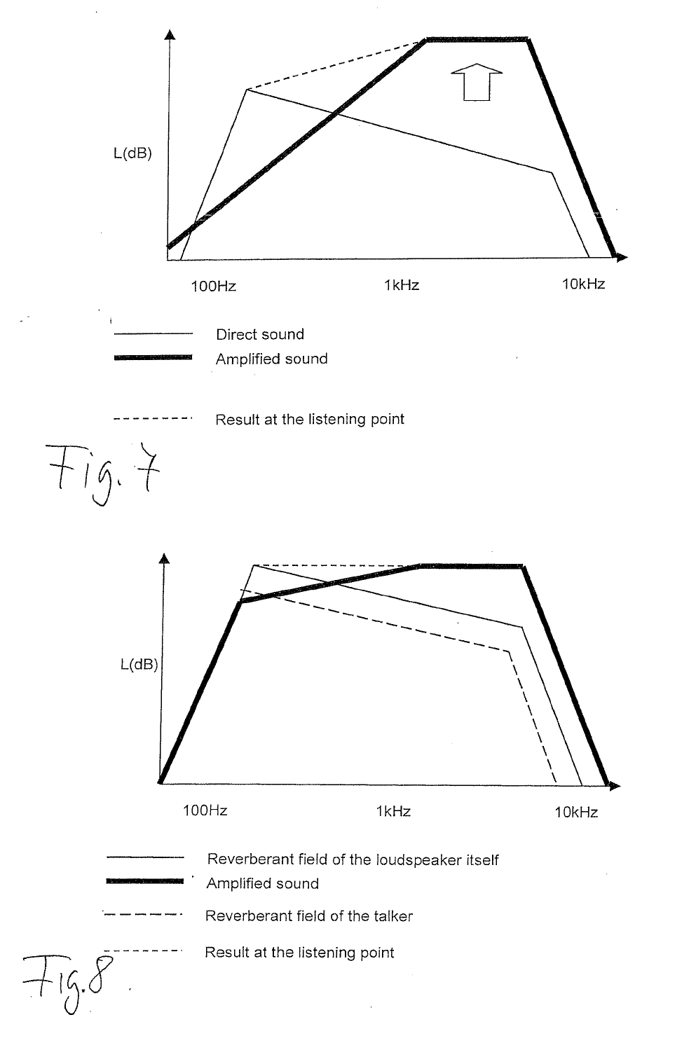

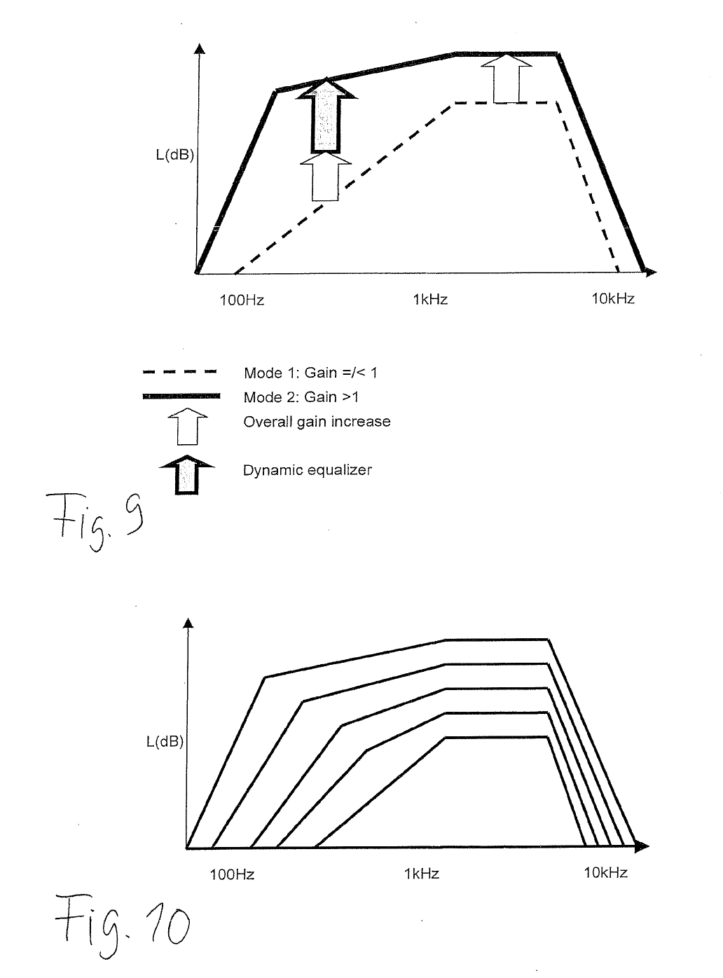

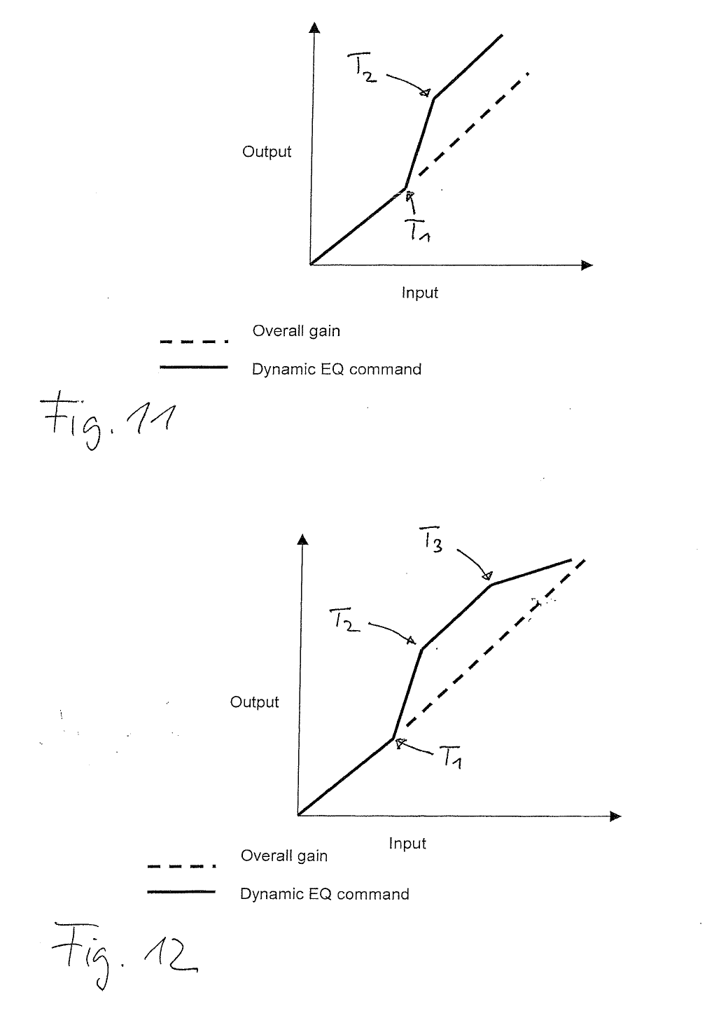

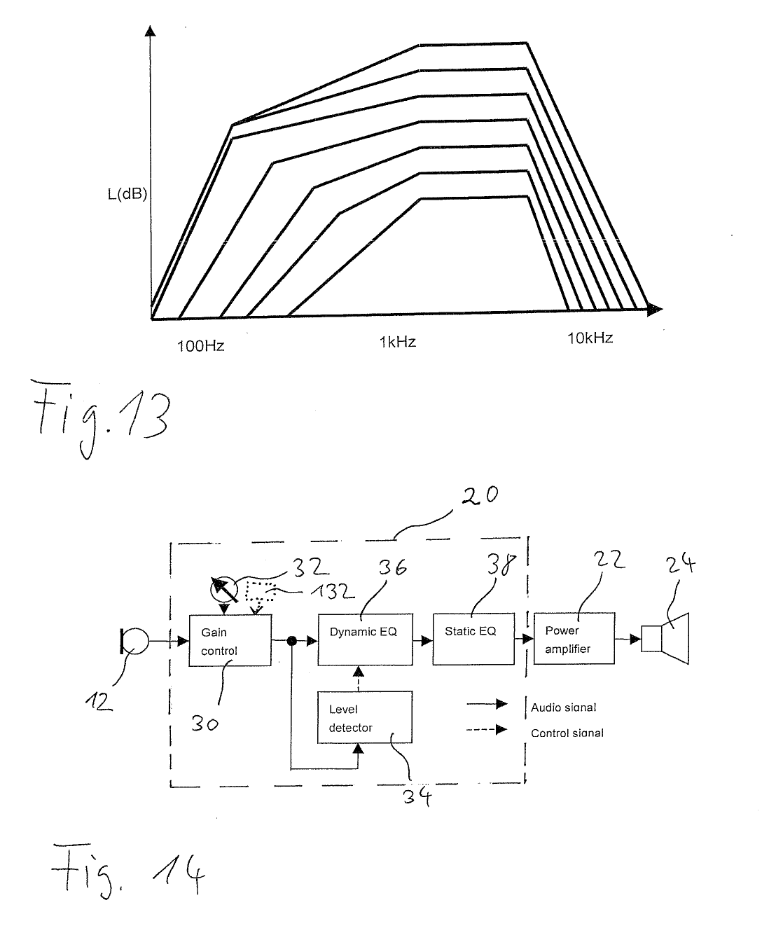

As an optional feature, the system may include a compensation with regard to the level dependence of the equal loudness contours (also called Fletcher-Munson-curves). This is shown in FIGS. 12 & 13. In this case, the shape of the frequency response curve selected in the audio signal processing unit 20 again depends on the gain once the gain has reached a third threshold point T3, which corresponds to the overall gain at which the level of the sound from the loudspeaker arrangement 24 at a listener's position in the room 10 is expected to be higher than the level of the sound from the speaker as perceived directly at the speaker's mouth. In this regime, the selected frequency response curve has a shape so as to compensate for the level dependence of the contours of equal loudness according to the difference between the level of the sound from the loudspeaker arrangement 24 at the listener's position in the room 10 and the level of the sound from the speaker directly at the speaker's mouth. In this regime, the level at lower frequencies of the selected frequency response curve is decreased with increasing overall gain relative to the level at higher frequencies.

The various threshold values of the total gain of the system thus define a plurality of operation modes:

(1) a first mode, wherein the gain does not significantly exceed a value of 1 and wherein a fixed first frequency response curve is selected, which has a shape so as to selectively increase the level at higher frequencies so as to approximate the free field frequency response of the speaker's voice by mixing sound reproduced by the loudspeaker arrangement with the reverberant sound field of the speaker's voice;

(2) a second mode, wherein the gain is between the first threshold and a second threshold which corresponds to the gain at which the sound from the loudspeaker arrangement is expected to partially mask the sound from the speaker (i.e., the gain at which the reverberant field of the sound from the loudspeaker arrangement is expected to partially mask the reverberant field of the sound from the speaker), and wherein a variable frequency response curve is selected which has a shape so as to progressively increase the level at lower frequencies with increasing overall gain relative to the level at higher frequencies in order to approximate the free field frequency response of the speaker's voice by mixing the sound reproduced by the loudspeaker arrangement with the reverberant sound field of the speaker;

(3) a third mode wherein the gain is between the second threshold and a third threshold corresponding to the gain at which the level of the sound reproduced by the loudspeaker arrangement at a listener's position in the room is expected to completely mask the level of the speaker's voice at the speaker's mouth, wherein a fixed second frequency response curve is selected having a shape so as to approximate, by the sound reproduced only by the loudspeaker arrangement, the free field frequency response of the speaker's voice;

(4) a fourth mode wherein the gain is above the third threshold and wherein a variable frequency response curve is selected having a shape so as to decrease the level at lower frequencies with increasing overall gain relative to the level at higher frequencies in order to compensate for the level dependence of the contours of equal loudness according to the difference between the level of the sound reproduced by the loudspeaker arrangement at the listener's position in the room and the level of the speaker's voice at the speaker's mouth.

The shape of the selected frequency response curve is determined according to the estimated overall gain and according to the acoustic parameters of the room and the loudspeaker arrangement. Preferably, the overall gain is estimated from the adjustment position of the gain control element and the acoustic parameters of the room and the loudspeaker arrangement. The acoustic parameters of the room may be predefined as that of a typical room in which the loudspeaker arrangement is to be used, or they may be determined in situ in a calibration mode of the system prior to starting speech enhancement operation. In such calibration mode a test signal may be supplied from the audio signal processing unit to the loudspeaker arrangement and the resulting test sound is captured by the microphone as test audio signals. The frequency response of the diffuse field and/or the RT60 may be estimated from the test audio signals. The acoustic parameters of the loudspeaker arrangement may be factory-programmed.

The level of the reverberant field of the speaker's voice may be estimated from the signal level of the audio signals captured by the microphone. The level of the reverberant field of the sound reproduced by the loudspeaker arrangement may be estimated from the levels of the processed audio signals at the input of the power amplifier.

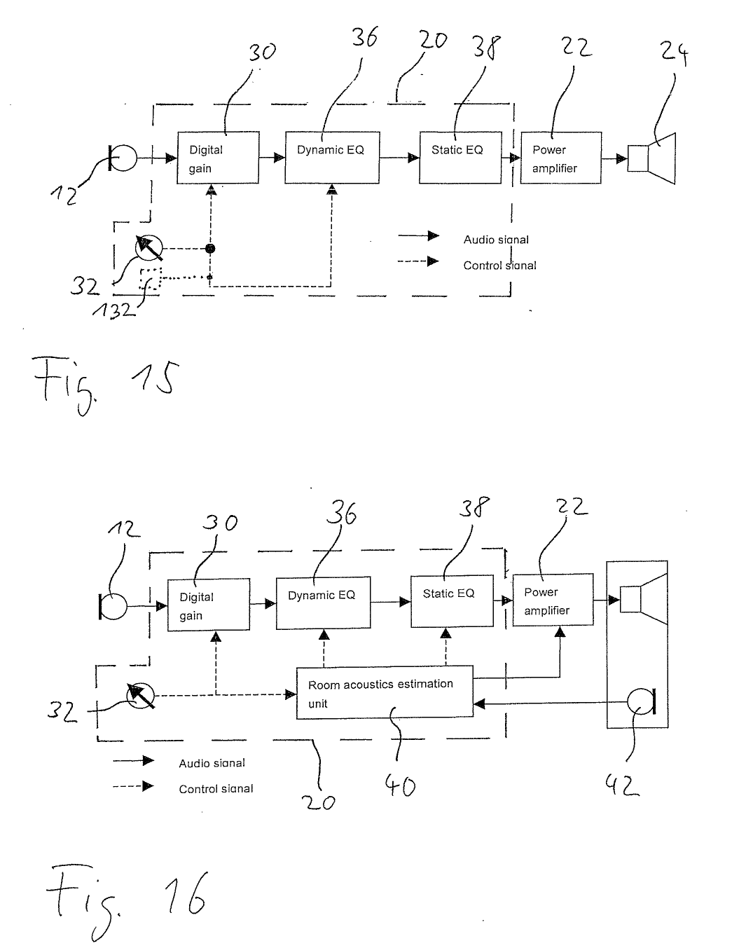

A block diagram of a first embodiment of a speech enhancement system according to the invention is shown in FIG. 14, wherein the audio signal processing unit 20 comprises a gain control unit 30 operated by a gain control element 32, a gain estimation unit 34 for estimating the overall gain from the level of the audio signals at the output of the gain control unit 30, a dynamic equalizer 36 which is a parametric equalizer and is controlled by the gain estimation unit 32 according to the estimated overall gain, and a static equalizer 38. The static equalizer 38 serves to provide for the fixed frequency response curve used in the first mode, in which the gain does not significantly exceed a value of 1. The dynamic equalizer 36 serves to change the shape of the frequency response curve as a function of the gain estimated by the gain estimation unit 34. The dynamic equalizer may be realized, for example, as a high-pass filter with a variable cutoff frequency or as a dynamic equalizer having a variable level. In the embodiment of FIG. 14, the gain control unit and the gain control elements 32 are analog and the acoustic room parameters necessary for determining the necessary shape of the frequency response curves and for determining the thresholds of the overall gain are factory-programmed as the acoustic parameters of a typical room, in which the system is to be installed. Also the acoustic parameters of the loudspeaker arrangement 24 (directionality, frequency response) are factory-programmed.

The gain control element 32 may be manually adjustable by the user of the system. Alternatively, it may be realized as an automatic gain control unit 132 (shown in dotted lines) which optimizes the gain of the system according to the presently prevailing use conditions (for example, as a function of the voice level and the ambient noise level) and supplies a corresponding gain adjustment signal to the gain control unit 30.

An alternative embodiment of a speech enhancement system is shown in FIG. 15, which differs from the system of FIG. 14 in that the gain control unit 30 and the gain control element 32 are designed as digital elements rather than as analog elements. In this case, the digital gain control element 32 may directly act both on the gain control unit 30 and the dynamic equalizer 36, so that no gain estimation unit for sensing the level of the audio signals at the output of the gain control unit 30 is necessary. Also, here, as in the other embodiments, the gain adjustment signal to the gain control unit 30 (and to the dynamic equalizer 36) may be provided by an automatic gain control unit 132 rather than by a manually operable gain control element 32.

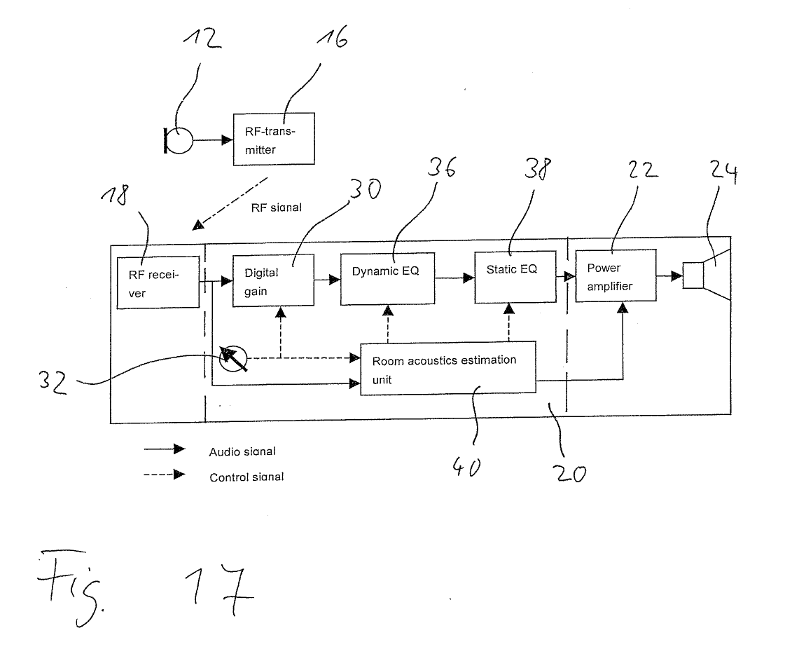

In FIG. 16, an embodiment of a speech enhancement system is shown, wherein the acoustic room parameters are estimated from a measurement performed in the actual room in which the system is installed, rather than using factory-programmed typical parameters. To this end, the audio signal processing unit 20 comprises a room acoustics estimation unit 40, which is able to generate, in a calibration mode of the system, a test signal, which is supplied to the power amplifier 22, in order to be reproduced by the loudspeaker arrangement 24 as a test sound. The test sound is captured by a microphone and is supplied to the estimation unit 40 (since, for the measurement of the acoustic room parameters, the microphone for capturing the test audio signals has to be placed in the area of the room where the listeners are located, usually an additional measurement microphone 42 will be necessary for this purpose, when the speaker's microphone 12 is not sufficiently movable). The estimation unit 40 estimates the frequency response of the diffuse field and/or the frequency-dependent RT60 from the captured test audio signals. Additionally, taking into account the loudspeaker parameters, the parameters necessary for determining the shape of the frequency response curves produced by the dynamic equalizer 36 and the static equalizer 38 are derived by the estimation unit 40 and are supplied as corresponding control signals to the dynamic equalizer 36 and the static equalizer 38. After calibration has been done, the dynamic equalizer 36 and the static equalizer 38 are parameterized according to the calibration measurement, and the gain status of the system is used to control the dynamic equalizer during normal use.

In FIG. 17, a modified system is shown, wherein the speaker's microphone 12 is a wireless microphone. In this case, the microphone 12 forms part of or is connected to a transmission unit 16 comprising an audio signal RF transmitter, and a corresponding RF receiver 18 is provided which supplies the received audio signal as input to the audio signal processing unit 20.

In this case, the speaker's microphone 12 can be used as the measurement microphone, since it can be easily placed in the listening area of the room 10.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1-34. (canceled)

35. A method of speech enhancement in a room, comprising the steps of:
determining acoustic parameters of the room and a loudspeaker arrangement located in the room,
capturing audio signals from a speaker's voice with a microphone,
processing the audio signals captured by the microphone with an audio signal processing unit, the audio signals being filtered by applying a selected frequency response curve to the audio signals captured,
generating sound according to the processed audio signals with the loudspeaker arrangement,
determining a value indicative of total gain applied to the captured audio signals, and
selecting a frequency response curve according to said total gain value and said acoustic parameters and applying the selected curve to the captured audio signals.

36. The method of claim 35, wherein the captured audio signals, prior to being processed in the audio signal processing unit, are pre-amplified in a preamplifier unit controlled by a gain control unit.

37. The method of claim 36, wherein the gain control unit is a manual gain control unit and wherein the total gain value is determined from an adjustment position of the manual gain control unit and said acoustic parameters.

38. The method of claim 36, wherein the gain control unit is an automatic gain control unit and wherein the total gain value is set by the automatic gain control unit to adjust the total gain according to actual acoustic conditions.

39. The method of claim 38, wherein said actual acoustic conditions comprise at least one of a level of the speaker's voice and an ambient noise level in the room.

40. The method of claim 35, wherein the acoustic parameters of the room are predefined as being that of a room of the type in which the loudspeaker arrangement is to be used.

41. The method of claim 35, wherein the acoustic parameters of the room are determined in-situ in a preliminary calibration mode.

42. The method of claim 41, wherein, in the calibration mode, a test signal is supplied from the audio signal processing unit to the loudspeaker arrangement and a resulting test sound is captured as test audio signals by the microphone or an auxiliary test microphone.

43. The method of claim 42, wherein a frequency response of at least one of a diffuse field and an RT60 is estimated from the test audio signals.

44. The method of claim 35, wherein a fixed first frequency response curve is selected as long as the total gain is below a first threshold.

45. The method of claim 44, wherein the fixed first frequency response curve has a shape which selectively increases an audio signal level at higher frequencies relative to a level at lower frequencies.

46. The method of claim 45, wherein the fixed first frequency response curve has a shape which approximates, when the total gain is at the first threshold, a free field frequency response of the speaker's voice by mixing an amplified sound from the loudspeaker arrangement with a reverberant sound field of the speaker's voice.

47. The method of claim 44, wherein the total gain at the first threshold is the total gain at which the loudspeaker arrangement is expected to radiate and is about the same as the overall acoustic power of the speaker's voice.

48. The method of claim 44, wherein a variable frequency response curve is selected as long as the total gain is at or above the first threshold and below a second threshold, and wherein, starting from the fixed first frequency response curve, a level at lower frequencies is increased with increasing total gain relative to a level at higher frequencies.

49. The method of claim 48, wherein each variable frequency response curve has a shape that approximates, at the respective total gain, a free field frequency response of the speaker's voice by mixing amplified sound from the loudspeaker arrangement with a reverberant sound field of the speaker's voice.

50. The method of claim 48, wherein the total gain at the second threshold is a total gain at which a reverberant field of amplified sound from the loudspeaker arrangement is expected to completely mask a reverberant field of the speaker's voice.

51. The method of claim 48, wherein a fixed second frequency response curve corresponding to a one of the frequency response curves that is closest to the second threshold is selected as long as the total gain is at or above the second threshold.

52. The method of claim 48, wherein the fixed second frequency response curve has a shape that approximates, by amplified sound from the loudspeaker arrangement, a free field frequency response of the speaker's voice.

53. The method of claim 48, wherein a variable frequency response curve is selected as long as the total gain is at or above a third threshold higher than the second threshold, wherein, starting from the fixed second frequency response curve, a level at lower frequencies is decreased with increasing total gain relative to a level at higher frequencies.

54. The method of claim 53, wherein the total gain at the third threshold is a total gain at which a level of amplified sound from the loudspeaker arrangement at a listener's position in the room is expected to be higher than a level of the speaker's voice at the speaker's mouth.

55. The method of claim 52, wherein each variable frequency response curve has a shape that compensates for a level dependence of contours of equal loudness according a difference between a level of amplified sound from the loudspeaker arrangement at a listener's position in the room and a level of the speaker's voice at the speaker's mouth.

56. The method of claim 35, wherein a level of a reverberant field of the speaker's voice is estimated from a signal level of the captured audio signals.

57. The method of claim 35, wherein the processed audio signals are amplified by a constant gain power amplifier to produce amplified processed audio signals which are supplied to the loudspeaker arrangement.

58. The method of claim 57, wherein a level of a reverberant field of the loudspeaker arrangement is estimated from a level of the processed audio signals at an input of the power amplifier.

59. The method of claim 35, wherein the captured audio signals are transmitted via a wireless link to the audio signal processing unit.

60. A system for speech enhancement in a room, comprising:
a microphone for capturing audio signals from a speaker's voice,
an audio signal processing unit for processing the audio signals captured by the microphone in a manner so as to filter the audio signals by applying a selected frequency response curve to the audio signals,
a loudspeaker arrangement to be located in the room for generating sound according to the processed audio signals,
means for estimating acoustic parameters of the room loudspeaker arrangement in the room,
means for determining a value indicative of a total gain applied to the captured audio signals,
wherein the audio signal processing unit comprises means for selecting and applying a frequency response curve to the captured audio signals according to the total gain value and said acoustic parameters.

61. The system of claim 60, wherein the system comprises a power amplifier for amplifying, at constant gain, the processed audio signals so as to produce amplified processed audio signals to be supplied to the loudspeaker arrangement.

62. The system of claim 60, wherein the system comprises a preamplifier unit, controlled by a gain control element for pre-amplifying the captured audio signals prior to being processed in the audio signal processing unit.

63. The system of claim 62, wherein the audio signal processing unit comprises a dynamic equalizer and a static equalizer.

64. The system of claim 63, wherein the dynamic equalizer is a parametric equalizer.

65. The system of claim 60, wherein the audio signal processing unit comprises a room parameter estimation unit which comprises means for generating test signals to be reproduced by the loudspeaker arrangement and for estimating acoustic parameters of the room from test audio signals captured by the microphone or a test microphone.

66. The system of claim 63, wherein the gain control element is digital, and wherein the dynamic equalizer is to be controlled by adjustment of the gain control element as said total gain value.

67. The system of claim 63, wherein the gain control element is analog and wherein a level detector is provided for measuring a level of the audio signals captured by the microphone and for outputting a control signal to the dynamic equalizer as said total gain value.

68. The system of claim 63, wherein the automatic gain control unit is operable for determining the total gain value so as to adjust the total gain according to actual acoustic conditions, including at least one of a level of the speaker's voice and an ambient noise level in the room, and wherein said total gain value is supplied as a control signal to the pre-amplifier unit and to the dynamic equalizer.

69. The system of claim 60, wherein the microphone forms part of or is connected to a transmission unit comprising a transmitter for transmitting the captured audio signals via a wireless link to a receiver unit, the receiver unit comprising a receiver for receiving the signals transmitted by the transmitter and the audio signal processing unit.
